(19) United States
(12) Patent Application Publication
(10) Pub. No.: US 2018/0013722 A1
(43) Pub. Date: Jan. 11, 2018

(54) DISTRIBUTED FIREWALL DEVICE AND SYSTEM

(71) Applicant: Eric Enos, College Grove, TN (US)

(72) Inventor: Eric Enos, College Grove, TN (US)

(21) Appl. No.: 15/203,555

(22) Filed: Jul. 6, 2016

(51) Int. Cl. H04L 29/06; G06Q 50/22

(52) U.S. Cl. CPC H04L 63/02; H04L 63/20; H04L 63/1441; G06Q 50/22; H04L 63/0823; H04L 63/1433

(57) ABSTRACT

A distributed firewall device that can be hardwired to a client device and securely connect the client device to a wireless network. The client device can be a medical device connected to a healthcare facility network. The distributed firewall device transmits allowed data packets received from the client device to the wireless network and transmits allowed data packets received from the wireless network to the client device using firewall and routing configurations stored in volatile memory. A wipe module in the firewall device clears firewall and routing configurations from volatile memory upon detecting a security threat. A reload device is used to load configurations onto new or wiped firewall devices and initially connect the loaded firewall devices to the wireless network.

### BACKGROUND

### Technical Field

The present invention relates generally to distributed firewall device and a method for using the device to wirelessly connect to a secure network. More particularly, this invention pertains to a distributed firewall device used to securely connect medical devices to a wireless network and protect connected network devices from attack.

### Description of Related Art

In several industrial, business and health market sectors, business organizations invest in large quantities of expensive and technically advanced capital equipment. Advantageously, in many instances, this equipment can be monitored or controlled by connecting the equipment to computer networks, allowing the equipment to be centrally controlled and monitored. Centralized management and control can significantly reduce costs.

But just as networking technology has evolved to enable this type of networking, so too has the sophistication of would-be attackers and the threats that they pose. There have been several notable instances where attackers have hacked into government, banking, defense and medical networks to maliciously control networked equipment and misappropriate trade secret information. Some of these attacks have been perpetrated by remotely hacking into these networks from the Internet by stealing or guessing the passwords needed to break into these networks. Other attacks have been perpetrated by physically accessing trusted devices in networks and infecting these trusted devices with malware, such as viruses, that spread to other trusted devices and enable attackers to access the networks using security weaknesses the malware creates.

To combat these threats, network security, including wireless network security has markedly and rapidly improved. Some new security systems have incorporated stronger authentication protocols and firewall systems to minimize unauthorized access to networks. Improved anti-malware, such as anti-virus and enterprise firewall systems have been developed to destroy infecting malware and prevent it from spreading to other networked machines. Although firewalls have been developed to provide perimeter protection for networks and guard network entry points from malicious intruders on untrusted networks such as the Internet, these firewalls often assume that data packets on the protected network can be trusted, so only data packets received from untrusted networks need to be scrutinized carefully. Later, enterprise-level firewalls were developed to be distributed at various points within a network. These firewalls made no assumptions about the topography of connected networks and made no assumptions that data packets on any connected network could be trusted. Thus enterprise firewalls scrutinize data packets irrespective of network topology.

These enterprise-level firewalls can be large and sophisticated. Generally they contain sensitive information, such as routing tables that contain the IP addresses of nodes and gateways on the network. Enterprise-level firewalls can also include firewall rulesets that describe security policies, identify permitted data connection types and communication protocols that may be permitted on the network. Enterprise-level firewalls can further include authentication data such as cryptographic certificates, as well as user and machine identifiers that may be useful to access the network. Accordingly, these enterprise firewalls are usually kept in secure locations where only trusted personnel can access them.

The constant need to upgrade the networking capabilities of expensive equipment to protect the equipment from developing threats can be costly. This is especially problematic when securing this equipment requires using enterprise grade security systems that may be accessible to an untrusted population. Attackers in the untrusted population can access the equipment to steal information contained in the security systems themselves or use the information to break into the wider network. In these situations, business organizations that use this equipment can be reluctant to connect the equipment to networks, being reluctant or unable to update the equipment because of cost, regulatory requirements, or concerns of liability in the event of modifying the equipment with unreliable updates.

Many healthcare providers, for example, depend on large numbers of expensive, modern medical devices for patient care. The medical devices can include portable, mobile and fixed assets, and can include ultrasound devices, infusion pumps, dialysis machines, and radiologic imaging equipment as well as monitors that measure and record a patient's body functions and physical condition. Although much of the equipment may be technically advanced from a medical perspective and well suited to their assigned tasks of treating and monitoring patients, frequently, these pieces of equipment contain legacy network devices only capable of rudimentary wireless network communication and implementing obsolete security measures that are easily overcome by malicious attackers.

Medical devices can be regulated by the U.S. Food and Drug Administration as class I, class II or class III medical devices, which may make modification of the internal components of the medical devices prohibitive from a liability perspective or even forbidden by regulation absent appropriate certifications. Even if permitted, many healthcare providers may be unwilling to incur the cost that would be required to safely modify otherwise suitable medical equipment to enable the equipment to securely connect to hospital networks using updated security protocols. Networking medical devices that use legacy networking capabilities can require hospital networks to use legacy security and communication protocols to enable the legacy devices to connect. Furthermore, because these medical devices must be left nearby patients in unsecured areas of hospitals, these devices do not include enterprise firewall and other anti-malware security systems. Thus, despite its trusted network status, medical device networks typically have poor protection and can easily be infected with malware and can be spread to other machines, presenting a serious threat to patients and the security of the hospital network.

To illustrate these problems, FIG. 1 is a diagram of a type of network that is generally available in hospitals. This exemplary network includes a virtual local area network or VLAN for hospital biomedical devices 104, and internal user VLAN accessible to hospital staff 103 (possibly limited to users having appropriate system log in credentials). The exemplary network can also include a guest VLAN 102 that may be made available generally to hospital visitors, and a network management system VLAN 101. Network management system VLAN 101 is typically restricted to network administrators and staff tasked with monitoring and controlling biomedical devices and managing patient health record storage. The network management system VLAN 101 can include network management and security servers 105, client device data and patient health record servers 106 and client unit management servers 107. Router 114 connects the network management system VLAN 101 to the biomedical device VLAN 104, the internal user VLAN 103 and the guest VLAN 102. Firewalls 115 and 116 provide perimeter protection isolating the management system VLAN 101 and internal user VLAN 103 from networks in unsecured areas of the hospital facility.

Guest user computers 117, 118 are shown connected to the guest VLAN 102. Medical facility computer 111, patient biomedical device such as an infusion pump 108, and a patient monitor 109 are shown wirelessly connected via wireless access point 101 to biomedical device VLAN 108. Additionally, biomedical device VLAN 104 can be hardwired to medical facility computers and devices 113. Computers used by hospital staff 112 are also shown connected to internal VLAN 103. As can be seen in FIG. 1, if a patient biomedical device 108 or computer 113 in an unsecured area of the hospital is infected by malware, there are no firewalls preventing the malware from spreading to other biomedical devices such as computer 111 or monitor 109. An attacker could access patient medical information stored on an infected device, or control and infusion pump 108, for example, to vary its operation in a way detrimental to the patient. Because enterprise firewalls would also be vulnerable to theft of sensitive network information if left in these unsecured areas, the hospital's network is weak and vulnerable to malicious attack.

Even if the wireless security of biomedical devices and the wireless access point 110 were improved to current standards, without enterprise firewall protection, biomedical devices would still be vulnerable to malware and other attacks from other devices on biomedical device VLAN 104 that are erroneously assumed to be secure. Therefore, a need exists for an improved firewall device to securely connect biomedical devices to a wireless network and also protect medical devices from other machines on the same network in an unsecured area.

### BRIEF SUMMARY OF THE INVENTION

In one embodiment, a distributed firewall device includes a processor coupled to a memory and to a network module for interfacing with a wireless network and a client device, the memory having a firewall program stored thereon. The firewall program can be configured to monitor network data that the network module receives from the wireless network and configured to permit transmission of allowed network data to a client device. The firewall program can also be configured to monitor client device data received from the client device and permit transmission of allowed client device data to the wireless network. To identify allowed network data and allowed client device data, the firewall program can use a configuration stored only in volatile memory. The firewall device can also include a wipe module stored in memory and configured to monitor the security state of the firewall device and to clear the configuration from memory upon detection of a security threat.

In some embodiments, the configuration of the firewall device can include a firewall ruleset, a routing table or a digital authentication certificate as well as combinations of these rulesets, routing tables and certificates. In additional embodiments of the firewall device, the wipe module can be configured to clear the configuration by clearing volatile memory. Also, in the firewall device, the security threat can include disconnection from the client device, disconnection from the wireless network, detection of one or more prohibited network data packets, or loss of power to the client device. In these embodiments, the client device can be a medical device.

Another embodiment provides a method in a reload device for connecting a firewall device to a wireless network that includes connecting the reload device to a client unit, the client unit including the firewall device having a wipe module and a client device, wherein the firewall device is hardwired to the client device. The method also includes receiving in the reload device a client unit identifier from the client unit, the client unit identifier uniquely identifying the firewall device and hardwired client device pairing; identifying, using the reload device and based on the received client unit identifier, a desired configuration; disabling the wipe module; loading the desired configuration into a volatile memory of the firewall device; controlling the firewall device, using the reload device, to connect to the wireless network using the stored configuration; and enabling the disabled wipe module.

In this embodiment, the client device can be a medical device. In addition, the communication configuration can include a digital authentication certificate, a firewall ruleset or a routing table as well as combinations of certificates, rulesets and routing tables.

Yet another embodiment provides method of protecting a client device comprising providing a client unit that includes a firewall device and a client device, the firewall device having volatile memory, non-volatile memory, and a wipe module in stored in non-volatile memory, the firewall being hardwired to the client device. In this embodiment, the firewall device can be connected to a wireless network using a configuration stored only in volatile memory, wherein the firewall device is configured to monitor network data the network module receives from the wireless network, only permitting transmission of allowed network data to a client device, and also configured to monitor client device data received from the client device, only permitting transmission of allowed client device data to the wireless network. Also, the firewall device can be configured to monitor the client unit for security threats and to control the wipe module to erase the volatile memory on detecting a first security threat. The method can further include controlling the firewall device to erase the volatile memory on detecting the first security threat and to disconnect from the secure wireless network.

Optionally in this embodiment, the client device can be a medical device. The configuration can include a digital authentication certificate, a firewall ruleset or a routing table as well as combinations of certificates, rulesets and routing tables. The security threat can include disconnection from the client device, disconnection from the wireless network, detection of one or more prohibited network data packets, or loss of power to the client device.

### BRIEF DESCRIPTION OF THE SEVERAL VIEWS OF THE DRAWINGS

FIG. 1 is an illustration of an exemplary prior art network for a healthcare service provider.

FIG. 2 is a diagram of an embodiment of a client unit connected to a network according to the present invention.

FIG. 3A shows an embodiment of the memory of a firewall device according to the present invention.

FIG. 3B shows the memory of FIG. 3A after the volatile memory has been wiped.

FIG. 4 is a flow diagram showing firewall device memory wipe scenarios.

FIG. 5A is a flow diagram of an embodiment of a method for creating a firewall device profile.

FIG. 5B is a flow diagram of an embodiment of a method for creating a client device profile

FIG. 5C is a flow diagram of an embodiment of a method for creating a reload device profile.

FIG. 6 shows an embodiment of a reload device.

FIG. 7 shows an embodiment of the reload device connected to the firewall device and a network management system during a reload operation.

FIG. 8 is a flow diagram of an embodiment of a method for reloading and configuring the firewall device to operate on a network.

### DETAILED DESCRIPTION OF THE INVENTION

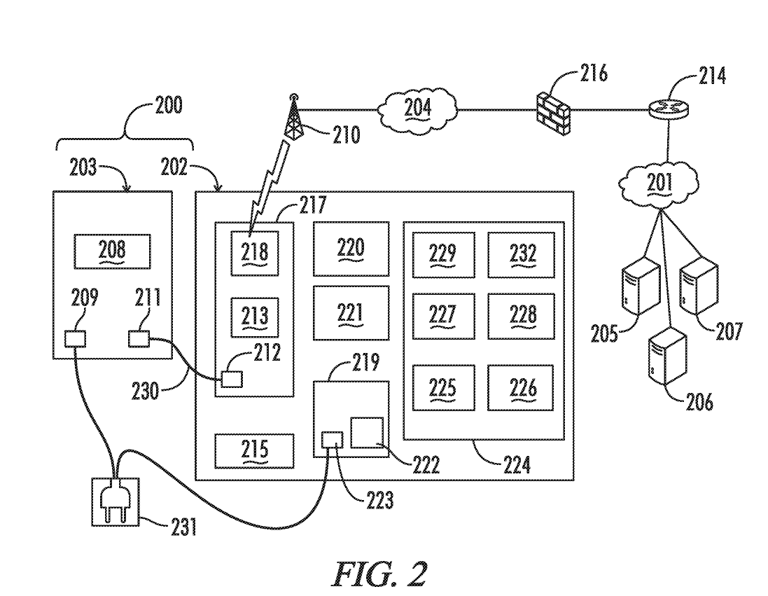

As shown in FIG. 2, one embodiment provides a client unit 200 being a distributed firewall device 202 hardwired to a client device 203. Client device 203 can be a medical device, such as a patient monitor that monitors a patient's physical condition, an infusion pump, a dialysis machine, a radiologic imaging device or an ultrasound device, for example. In some embodiments, client device 203 can be a medical device that falls under a U.S. Food and Drug Administration classification, such as a class I, a class II or a class III medical device, and can further be a legacy medical device that does not support currently available secure network communication standards such as 802.1X EAP-TLS or newer standards.

It will be understood that a medical device can be an instrument, apparatus, implement, machine, contrivance, implant, in vitro reagent, or other similar or related article, including a component part, or accessory which is: recognized in the official United States National Formulary, or the United States Pharmacopoeia, or any supplement to them; intended for use in the diagnosis of disease or other conditions, or in the cure, mitigation, treatment, or prevention of disease, in man or other animals; or intended to affect the structure or any function of the body of man or other animals, and which does not achieve any of its primary intended purposes through chemical action within or on the body of man or other animals and which is not dependent upon being metabolized for the achievement of any of its primary intended purposes.

In several of these embodiments, client device 203 can include a wireless communication module 208 for establishing and maintaining a communication link to exchange data over a wireless network. However, especially where client device wireless communication module 208 is a legacy device unable to establish a sufficiently secure wireless connection to a wireless access point 210, module 208 is disabled from producing a wireless signal.

To establish a secure wireless connection, client device 203 can be hardwired to firewall device 202 via a physically secured data cable 230 connected between client device data port 211 and firewall device data port 212. Data cable 230 can be physically secured as is known in the art by, for example, locking the cable to client device data port 211 and firewall data port 212 to prevent the cable from being removed from the ports, providing cable 230 with an armored sheath to prevent the cable from being cut, and by enclosing cable 230 and ports 211 and 212 behind hardened mounting brackets between firewall device 202 and client device 203. As will also be understood, the firewall device can further monitor the continuity of the data cable and its connection from firewall device 202 to the client device 203, using a security module for example 215, to check that the cable 230 is properly in place and has not been disconnected or cut. Although FIG. 2 shows security module 215 as a separate unit, it will be understood that the module can be located anywhere within firewall device 203 or fragmented as part of other modules consistent with the device's design and operation.

Via client device power port 209 and firewall power port 223, power cable 231 can connect the client device 203 and firewall device 202 to an external power supply. Optionally, as shown in FIG. 2, power cable connects both devices 202 and 203 to the external power supply through the same connector, preventing the client device 203 from being powered and operated without power to the firewall device 202.

Firewall device 202 includes processor 221, input and output or I/O module 220, memory 224, firewall network module 217, security module 215 and power module 219. Device 202 can be enclosed in an anti-tamper sealed case that minimizes the ability of, and preferably prevents, end users from accessing the internal circuitry of the firewall device 202 without also rendering the firewall device 202 inoperable. The internal modules of firewall device 202 can be accommodated on a suitably modified and open architecture computing device such as the Raspberry PI Zero computing device, which is available at https://www.raspberrypi.org/products/.

As will be understood by those skilled in the relevant art, processor 221 is operatively coupled to I/O module 220, memory 224, firewall network module 217, security module 215 and power module 219. I/O module 220 receives input from user interfaces such as a keyboard or touch screen device and converts the input into a suitable form for the processor 221. Conversely, I/O module 220 receives output from processor 221 and converts that into a form suitable to be received by user interfaces such as a display monitor or a touch screen device. However, to minimize the firewall device's vulnerabilities, the I/O device 220 can disable communication with user interfaces that are not needed for operation of the firewall device 202, thus limiting the risk of attack by a malicious user. Power supply module 219 receives electrical power through power port 223 from an external power supply and converts the received electrical power into a form suitable for internal components and modules of firewall device 202 to consume. Power module 219 can also include a battery 222 to produce electrical power which can similarly be converted into a form that internal firewall device components can consume. Battery 222 can serve as a backup power supply for firewall device 202 or as a main power supply that is kept charged by external power supplied through power port 223.

Security module 215 receives input from various sensors in firewall device 202 that security module 215 monitors to detect the existence of potential security threats. In some embodiments, if the security module detects a security threat, it generates an alarm that is transmitted to the processor 221 which, under control of a security program directs the firewall device 202 to take further action. As one example, sensors can include a data cable continuity sensor that monitors the continuity of the connection that data cable 230 provides between client device 203 and firewall device 202. Sensors can also include a power service sensor that monitors firewall power port's 223 connection to an external power supply and the charge level of battery 222. The power service sensor can generate alarms if the external power supply is disconnected or if the battery charge level falls below a desired level, such as 5% charge remaining. Further sensors can include a case sensor that monitors the condition of the case and determines whether the firewall device's case has been opened or ruptured. The case sensor can include, for example, switches placed at strategic positions in the case to detect that the case has been opened or a number of conductors extending along the internal surface of the case that are designed to break if the case is breached. The security module 215 can detect if the case is breached if a switch is triggered or the continuity of one of the perimeter conductors is broken.

Security module 215 can optionally include a dedicated processor, separate from processor 221, as well as its own volatile and non-volatile memory such as a RAM and ROM, respectively. In some embodiments, using either the dedicated processor and memory or the firewall device's central processor 221 and memory 224, the security module 215 can include programming and data to receive various alarm generated by other modules of the firewall device 202 and determine whether to initiate a volatile memory wipe by sending a wipe signal to the wipe module 232.

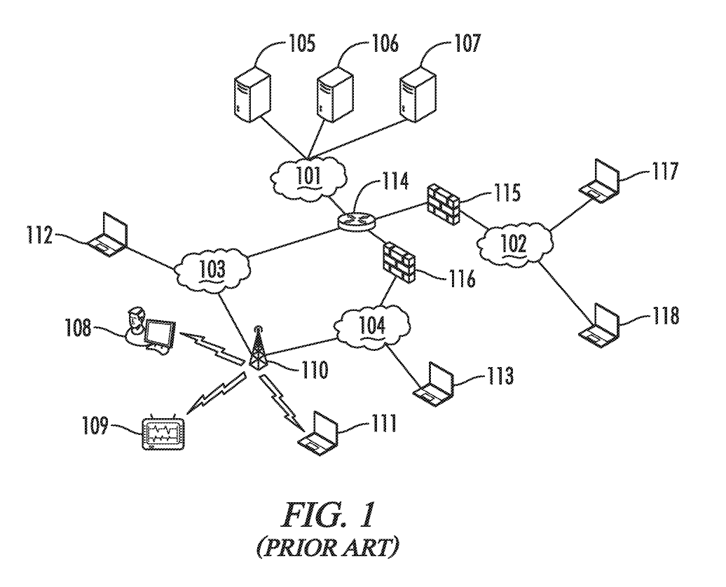

Wireless radio 218 in network module 217 receives and transmits a wireless signal to establish a wireless connection and communicate securely with wireless access point 210. Wireless access point 210 can be part of an enterprise network similar to FIG. 1, a portion of which is shown in FIG. 2. The enterprise network can be part of a healthcare services provider's network (such as a hospital's network).

Network module 217 can also include reload radio 213 that can securely communicate wirelessly with a reload device and with wireless access point 210 to set up firewall device 202 for initial use on the wireless network or after a memory wipe. As noted previously, data port 212 in network module 217 is connected to client device data port 211 via data cable 230 to exchange data with client device 203. Network module 217 can communicate with client device 203 consistent with an agreed communication protocol. Thus, when network module 217 receives data from other firewall device modules, it can convert the data into a signal in accordance with applicable protocols and transmit the data to a device outside the firewall device 202 via data port 211, reload radio 213 or wireless radio 218. Conversely, network module 217 can receive data from these ports and radios, convert the data into a suitable format, and forward the converted data to the appropriate module.

In some embodiments, network module 217 can communicate via data port 211 using an Ethernet networking protocol such as IEEE 802.3 consistent with the 802.1X EAP-TLS standard. Similarly, network module 217 can communicate via wireless radio 218 to wireless access point 210 or via reload radio 213 to a reload device using an 802.11x wireless protocol consistent with the 802.1X EAP-TLS or IEEE 802.11i-2004 standards. The network module 217 can optionally communicate via reload radio 213 using a secure Bluetooth protocol. It will be understood that in these communications both inside the firewall device 202 and between the firewall device 202 and other network nodes, data can be transmitted in the form of data packets.

Memory 224 of firewall device 202 includes volatile memory, which can be random access memory or RAM. As known in the art, volatile memory retains stored data and information only while the memory is powered. This memory loses stored information and data when the memory loses power. In addition to volatile memory, memory 224 can include non-volatile or permanent memory in which information and data can remain stored even when power is removed from the memory. Non-volatile memory can include flash memory, read only memory—also called ROM, and hard drives. Processor 221 loads programs and data stored in memory 224 and directs the firewall device 202 to operate as controlled by the loaded programs running on the processor 221.

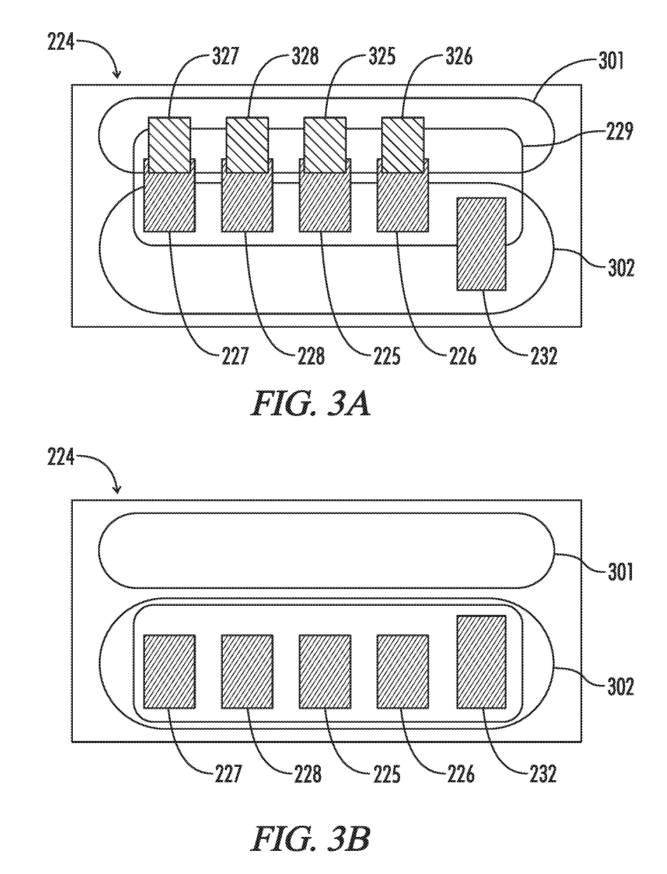

In the embodiment shown in FIG. 2, programs and data stored in memory 224 include operating system 229, routing module 227, firewall module 228, intrusion detection system or IDS module 225, management module 226 and wipe module 232. Associated with each of the routing module 227, firewall module 228, IDS module 225 and management module 226 is a corresponding configuration file, namely a routing configuration file, a firewall configuration file, an IDS configuration file and a management configuration file. FIG. 3A shows an embodiment of memory 224 in further detail including volatile memory 301 and non-volatile memory 302. Operating system 229, routing module 227, firewall module 228 IDS module 225, wipe module 232 and management module 226 can reside in non-volatile memory 302 for permanent storage so they can be available for use by firewall device 202 whenever it is restarted after being powered down. However, when the firewall device is powered up and processor 221 is to run one or more of the modules, the necessary portions of the operating system 229 and modules can be loaded into volatile memory 301 where processor 221 can retrieve relevant portions of their program instructions and data for execution.

Operating system 229 directs the operation of the firewall device 202 and provides an interface between the modules and the hardware of the firewall device 202, converting commands or data transmitted from modules into a form useable by the hardware and commands or data transmitted from or through hardware into a format useable by the modules.

In order to securely connect to the wireless access point 210, monitor the flow of data between network 204, which can be a wireless local area network, and the client device 203 and to block the flow of unauthorized or prohibited network data packets, firewall device 202 additionally uses configurations, which can be individual pieces of configuration data or data organized into configuration files stored only in volatile memory 301. These configurations can include routing configuration data or file 327, firewall configuration data or file 328, IDS configuration data or file 325 and management configuration data or file 326, for example. These configurations can contain sensitive information that an unauthorized attacker could use to access the network and to break through the firewall device's defenses. Digital certificates that the firewall device 202 uses to authenticate its secure connection to the wireless network via network access point 210 and to access network resources can also be stored in these configurations or elsewhere in volatile memory to be used by the modules or the operating system 229.

According to one embodiment, the routing module 227 can use the data in the routing configuration file 327 to direct a data packet received at network module 217 to a network address indicated in the data packet, if necessary, via an intermediate network node. The routing configuration file 327 can include a routing table which is a lookup table that firewall device 202 can use to forward a data packet to an address on a directly connected destination network, or forward the data packet towards a remote destination network. Each destination network listed in the routing table can be identified by a network identifier that can include the destination network address as well as the address of a destination host computer on that network. The routing table can also include a corresponding gateway computer address. A gateway is a network node that serves as an entrance to another network and for purposes of routing can be a node through which a remote destination can be reached. For each destination address, the routing table can further include the address of a local interface through which the received data packet should be sent to reach the corresponding gateway, and also a metric that indicates the associated cost of using the indicated route.

Firewall module 228 can use the data in the firewall configuration file 328 to determine which data packets received at network module 217 to forward on towards the packet's destination address and which packets are not authorized and should be blocked. This determination can be based on a firewall ruleset included in firewall configuration file 328. The firewall ruleset can include, for example, an encoded form of network policies requiring the firewall module 228 to inspect all data packets, whether originating from the client device 203 via the hardwired connection to data port 212 or from other devices directly connected to wireless local area network 204, or indirectly connected via other networks. The firewall ruleset can also require the firewall device to inspect data packet headers and data packet contents and to also track the operating state and characteristics of network connections traversing the firewall. By inspecting data packet headers and contents, for example, the firewall module 228 can determine the source of a data packet from its header and limit its onward transmission depending on its contents. Similarly, firewall module 228 may only allow transmission of data packets from certain sources or to certain destinations based on the state of network communications. Thus, for example, firewall module may block certain data packets to the client device if the client device has not previously opened a network connection requesting the type of data contained in the received data packet.

Intrusion detection system or IDS module 225 can analyze data packets received from client device 203 via data port 212 as well as data packets received from a wireless network via wireless radio 218. Optionally, the IDS module 225 can monitor data packets transmitted via the network module 217. By inspecting data packets transmitted and received through network module 217, IDS module 225 can respond to suspicious behavior and attacks involving data packets, whether the source of the malicious data packets is in the client device, the network connected via wireless radio 218 or even a source that has somehow found its way into firewall device 202 itself. To analyze data packets and respond to attacks, the IDS module 225 uses signature which include information describing characteristics and patterns of malicious data packets that IDS module 225 matches to data packets or patterns of behavior to identify an attack. The signatures can be included in the IDS configuration file 325. Configuration file 325 can also include information and instructions to control when and how IDS module 225 responds to malicious data packets it detects among the received data packets. Based on this information and data, the IDS module can generate an alarm and log the detection event in a data file stored, for example, in an encrypted file in non-volatile memory 302, or securely transmitted to a network management console. Similarly, based on instructions in the IDS configuration file 325, IDS module 225 can transmit an alarm it generates to a network management console on the network or to an internal component of the firewall device 202 such as the security module 215, the firewall module 228 or the wipe module 232, for example.

In addition to information that the IDS module 225 may log, the management module 226 can monitor additional client unit information and log that information to establish baseline norms and to detect patterns of suspicious behavior. Information that management module 226 monitors can include, for example, power consumption of the client device 203, the activity levels and power consumption of the client device 203 over time, network log in attempts, as well as parameters characterizing the operation of the client device 203 that may be transmitted in the information in data packets received by the firewall device 202. Similar to the IDS module 225, in some embodiments, the management module 226 can log the information it monitors in non-volatile memory 302 or securely transmit the data to be logged to a central network management system. In further embodiments, the management module 226 can also generate alerts if suspicious activity is detected. Management configuration file 326 can include information that the management module 226 can use to perform its monitoring and logging functions, such as malicious activity and malicious data signatures that the management module 226 can compare against monitored data and activity to identify attacks, instructions and encoded policies that control the management module to monitor and log certain data, the location where the logged information should be stored, and criteria for generating and transmitting alarms.

Wipe module 232 can be stored in memory 224 together with or separately the operating system 229 routing, firewall, IDS and management modules. Wipe module 232 can be stored in non-volatile memory 302, and loaded into volatile memory 301 to be executed by processor 221. However, in some embodiments, the wipe module 232 can be stored on a dedicated, separate non-volatile memory such as a read only memory or ROM and optionally can be executed by a dedicated processor separate from processor 221. As a further alternative wipe module 232 can be completely implemented in hardware. In response to instructions or alarms it can receive from security module 215, routing module the firewall module, the IDS module or the management module, the wipe module 232 can wipe all instances of the routing configuration file 327, the firewall configuration file 328, the IDS configuration file 325 and the management configuration file 326 that exist anywhere on the client unit 200 by clearing volatile memory 301. For example, in response to alarms or instructions it receives, wipe module 232 can interrupt the power supplied to volatile memory 301 immediately clearing all information and data that volatile memory 301 previously stored.

It will be understood that the routing configuration file 327, the firewall configuration file 328, the IDS configuration file 325 and the management configuration file 326 can contain sensitive information that could assist a malicious network user to attack the network. For example, with the information contained in configuration files, an attacker could learn the network addresses of key nodes, such as gateways and host computers, the types of data, communications and connections permitted on the network and allowed through firewalls, as well as the types of behavior that could cause IDS modules and management modules to trigger alarms. Advantageously, by erasing all instances of the configuration files on a client unit 200 upon detecting an attack, whether the attacker tampers with the case of the firewall device 202, disconnects the firewall device 202 from the client device 203 or power source, or attempts to remove the entire client unit 200 from the wireless network of network access point 210, the wipe module 232 prevents this sensitive information from getting into the hands of an attacker.

During normal operation, the wireless communication module 208 in client device 203 is disabled so that, as shown in the embodiment of FIG. 2, data transmitted from client device 203 passes through firewall device 202 via a secure wireless connection from wireless radio 218 to wireless access point 210. Wireless access point 210 can be part of a dedicated local network for similar types of devices. For example, in a medical care facility where client device 203 is a medical device, a dedicated local network for similar types of devices could be a biomedical device virtual local area network, or biomedical device VLAN 204. Wireless access point 210 can be associated with a connected authenticator computer on VLAN 204 that limits access to VLAN 204 and other remote networks, such as management system virtual local area network, or management system VLAN 201 to properly authenticated devices and client units. Remote networks can be connected to VLAN 204, as known in the art, via devices such as firewall 216, which helps to secure the perimeter of VLAN 204, and router 214, which directs the flow of appropriately addressed data packets between VLAN 204 and remote networks, such as management system VLAN 201.

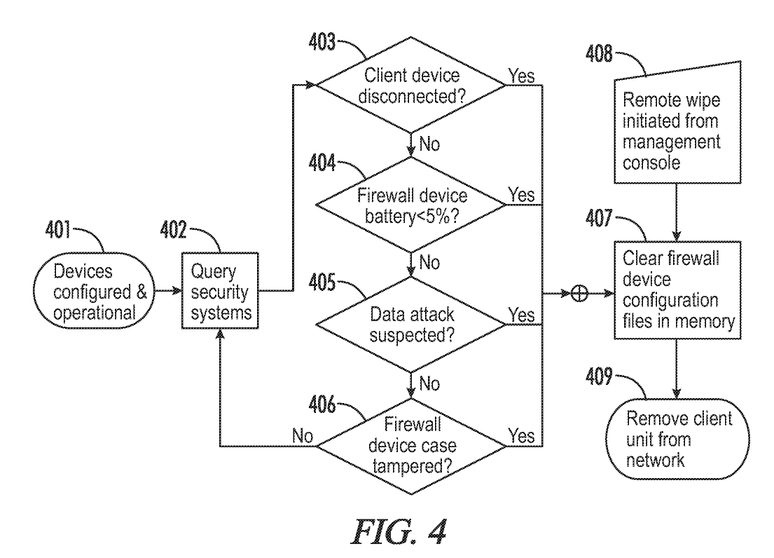

FIG. 4 is a flow chart describing an aspect of the operation of firewall device 202. In the first block 401, the flowchart begins with firewall device 202 in normal operation, properly configured and connected to client device 203 and to wireless access point 210. At least periodically in 402, firewall device 202 queries its security systems, for example by a request from processor 221 or security module 215 to the relevant module seeking a status update 402. It will be understood that in some embodiments, similar functionality can be achieved by configuring the relevant modules to constantly check the security systems and to send an interrupt or an alarm signal to the security module 215 or processor 221 whenever a suspected security threat is detected.

In the embodiment shown in FIG. 4, and as block 403 illustrates, a query can first be transmitted to security module 215 to determine the continuity of the hardwired connection between firewall device 202 and client device 203. If data cable 230 shows poor or no continuity in its connection between client device data port 211 and firewall device data port 212 (indicating that data cable 230 is not properly connected), security module 215 can send a wipe signal to wipe module 232. Alternatively, if there is good continuity and data cable 230 is properly connected, a query can be sent to the power supply module 219 in the next step 404 to determine the charge level of battery 222 or the supply of electrical power to power port 223. If in 404, the battery is properly charged and if power port 223 is receiving an adequate supply of electrical power the process moves to the next decision block 405. In 405, a query can next be sent to the firewall module 228, the IDS module 225 or the management module 226 to determine whether any malicious data packets have been transmitted to the firewall device 202, or whether other suspicious patterns have been detected in network traffic 405. If no data attacks have been detected in 405, block 406 shows a query in security module 215 to check the status of the firewall device case. If the case has not been tampered in 406, firewall device 202 continues normal operation and returns to block 402 to begin a fresh series of security system queries. However in 407, if the power supply battery 222 is losing charge, i.e. charged less than 5% for example, if power supply module 219 does not receive adequate power, if a data attack is suspected or if the firewall device case has been tampered, processor 221 or security module 215 can transmit a wipe signal to wipe module 232, causing the wipe module 232 to clear one or more configuration files in stored in the volatile memory 301 of firewall device 202. Alternatively in 408, a remote wipe signal can be transmitted to the firewall device 202 from management console to initiate step 407 and clear configuration files.

As previously explained, the wipe module 232 can clear the configuration files by interrupting electrical power supplied to volatile memory 301. It will be understood that the digital certificates the firewall device 202 uses to authenticate itself on the network can be stored exclusively on volatile memory 301. With volatile memory cleared, the firewall device's wireless connection to wireless access point 210 is terminated in 409.

The management system VLAN 201 can include servers that manage the operation and security of connected networks and virtual networks, as well as some aspects of the operation of host devices and client units 200 connected to those networks. Accordingly, management system VLAN 201 can include network management and security servers 205, client device data servers 206 and client unit management servers 207.

In some embodiments, network management and security servers 205 manage the operation and security of the entire network, and can include management consoles having user interfaces such as monitors and keyboards to facilitate user input and monitoring of system information. These servers can include programs and information to manage the network, such as equipment inventories, system provisioning, user and equipment authentication (including authorization) and network access control systems and databases, routing tables and rules, firewall policies and rules, intrusion detection and protection systems and policies, and network management logging policies and rules.

Network management and security servers 205 can optionally support remote administration of network devices using highly secure authentication protocols and support for RADIUS, LDAP and TACACS as well as multi-factor authentication. Digital certificates used to authenticate network devices can also be stored on these network management and security servers 205.

Client device data servers 206 can be used to store data received from client units 200 that relate to the primary function of the client devices 203. Thus in a healthcare facility where the client devices 203 are medical devices, the data received may represent patient electronic health records. It will be understood that especially in a large medical facility with numerous patients, the electronic health records should be securely stored for patient confidentiality and correctly matched with the particular medical device used to generate the data. Optionally, client device data servers 206 are also configured to be accessible by medical staff from other computers and devices on other local networks in the healthcare provider's network system so they can retrieve pertinent information to treat patients. Accordingly, the client device data servers 206 can include a secure database system for storage and retrieval of patient health records and data generated by corresponding networked medical devices.

Client unit management servers 207 can be used to set up, deploy and manage the operation and security of client units 200. These management servers 207 can contain an inventory identifying client devices 203, firewall devices 202 that are available to the enterprise, identify which devices have been deployed and are active on the network, and identify client device 203 and firewall device 202 pairings. The inventory can be stored in a secure client unit database on the client unit management servers 207 together with additional information such as device profiles that identify the locations, attributes and functions of the devices, as well as device configurations that can include encoded rules and policies of how the device should operate on the network. The configurations can also include profile information and digital certificates associated with the device that can be used for authentication purposes and to determine a device's permitted network behavior and access to network resources. The client unit database can further include an inventory of reload devices that can be used to deploy client devices 203 and firewall devices 202.

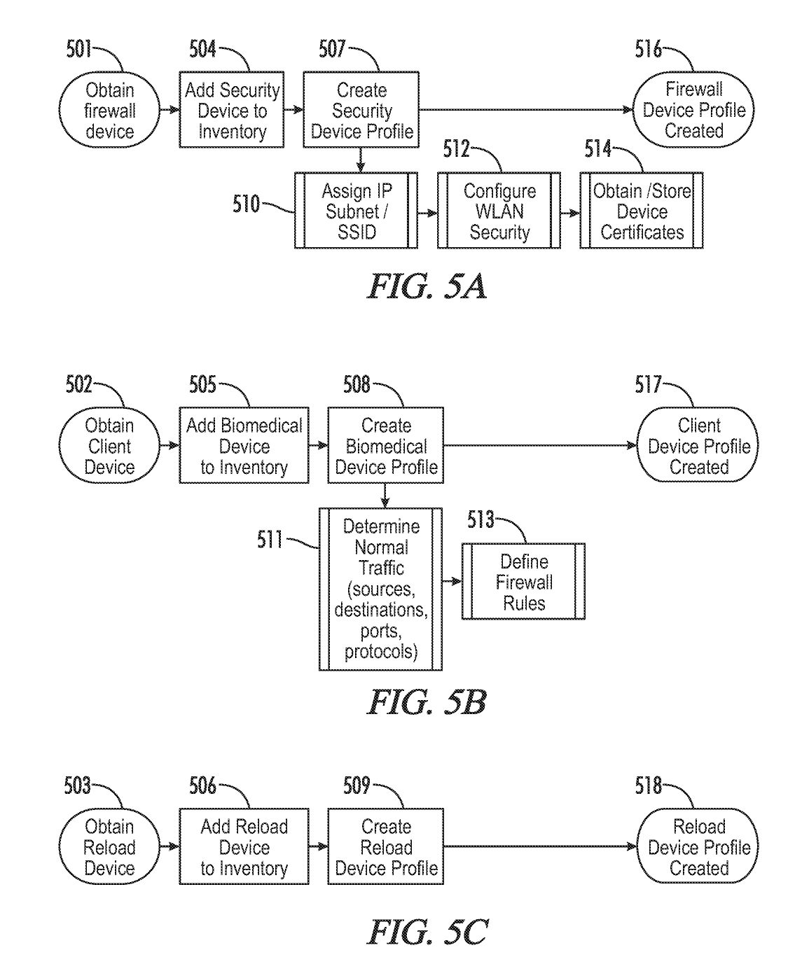

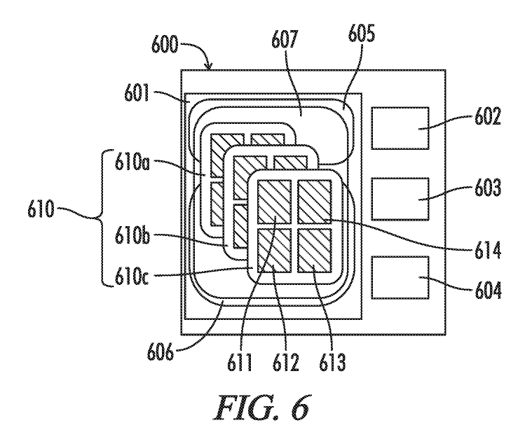

FIGS. 5A, 5B and 5C respectively show steps used to set up firewall device 202, client device 203 and reload device 600 (shown in FIG. 6). To set up a firewall device profile starting in step 501, a firewall device 202 can be obtained and identifying information (such as a unique identifying serial number) can be added to an inventory database on the client unit management server 207 in step 504. Based on the firewall device's unique identifier, in step 507, server 207 can generate a profile associated with the specific firewall device 202 using, for example, information and policies network managers load into the system regarding the functional attributes and intended use of the firewall device 202. Server 207 can also assign a network address and broadcast identifier (subnet and SSID) to the firewall device 202 in step 510. In step 512 the server 207 can configure the security to be used for the firewall device 202, such as by setting up database entries in appropriate authentication servers and assigning required network access control protocols and requirements within server 207 or in network management and security servers 205. In step 514, the server can obtain a digital authentication certificate for the firewall device 202 and store the certificate in appropriate server databases. Steps 510, 512 and 514 can be performed in parallel with completing the creating the firewall device profile 516.

To begin setting up a profile for a client device 203 starting in step 502, a client device 203 can be obtained and identifying information (such as a unique identifying serial number) can be added to an inventory database on the client unit management server 207 in step 505. Based on the client device's unique identifier, in step 508, server 207 can generate a profile associated with the specific client device 203 using, for example, information and policies network managers load into the system regarding the functional attributes and intended use of the client device 203. Using this profile information in step 511, server 207 can determine normal traffic rules to be associated with this client device 203, such as the network addresses of network nodes that can serve as potential and permitted sources of data packets sent to this specific client device 203 as well as permitted ports, communication protocols and destination addresses for data packets the client device can send and receive. These rules can be derived from network firewall policies network managers can set up in a policy database on server 207, along with the associated actions a firewall should take on inspecting a data packet, and rules governing the policies that should apply to the various types of devices on the network. Using these policies, in step 513 server 207 can generate a set of firewall rules to be incorporated into the configuration of an associated firewall device 202. The policies can also inform rules for generating routing tables and configurations as well as firewall device IDS and management configurations. Steps 511 and 513 can be completed in parallel with finalizing the creation of client device profile in step 517.

To begin setting up a profile for a reload device 600 starting in step 503, a reload device 600 can be obtained and identifying information (such as a unique identifying serial number) can be added to an inventory database on the client unit management server 207 in step 506. Based on the reload device's unique identifier, in step 509, server 207 can generate a profile associated with the specific reload device 600 using, for example, information and policies network managers load into the system regarding the functional attributes and intended use of the reload device 600. This profile information can include digital certificates, communication protocols and network access control parameters the reload device 600 can use for authentication and to access the network and communicate with network management and security servers 205 when deploying client units 200. Client unit management server 207 completes creating the reload device profile in step 518.

According to an embodiment of the reload device shown in FIG. 6, reload device 600 can include a processor 602 operatively coupled to memory 601, a network module 604 having a reload radio for communicating with firewall device reload radio 213 and a wireless radio for communicating with wireless access point 210, as well as an I/O module 603 for receiving input and generating output for a user interface such as a touch screen display. Memory 601 can include volatile memory 607 and non-volatile memory 606. Optionally, routing configurations 611, firewall configurations 612, IDS configurations 613 and management configurations 614 for loading onto firewall device 202 can be stored in memory 601. Configuration data can be stored in the reload device 600 in the form of configuration file sets 610a, 610b and 610c for different firewall devices 202. It will also be understood that configurations 611, 612, 613, 614 can also be in the form of separate files. Memory 601 can further include programming and data to enable reload device 600 to communicate securely with firewall devices 202 and with wireless access point 210, to enable reload device to control a connected firewall device 202 with a cleared volatile memory to receive and store configurations and other data from the reload device 600, and to control the firewall device 202 to communicate with wireless access point 210.

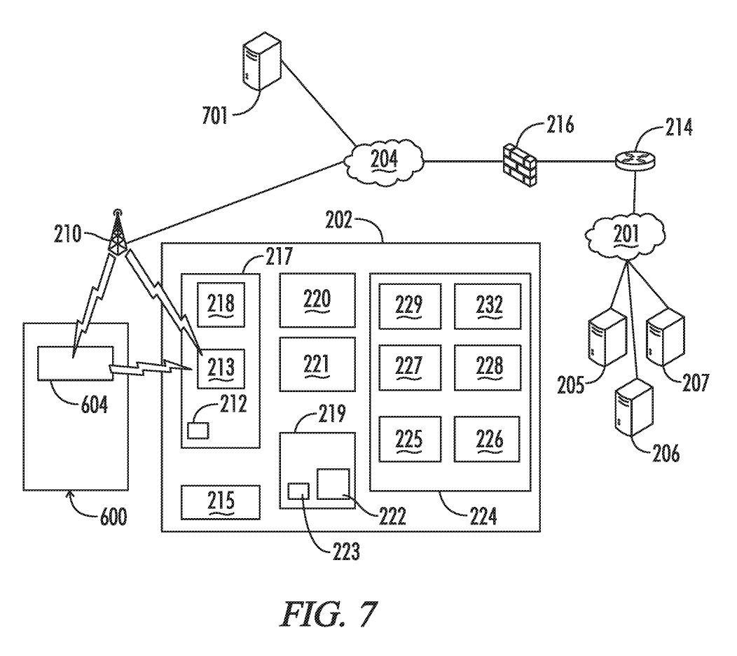

FIG. 7 is a shows an embodiment of a networked system having reload device 600 connected using its network module 604 to wireless access point 210 and to the reload radio 213 of firewall device 202. It will be understood that firewall device 202 can be connected to a client device via a data cable (not shown in FIG. 7) connected to data port 212. These wireless connections can be established using the reload device 600 to set up a new client unit 200 or to reload a firewall device 202 that has been wiped.

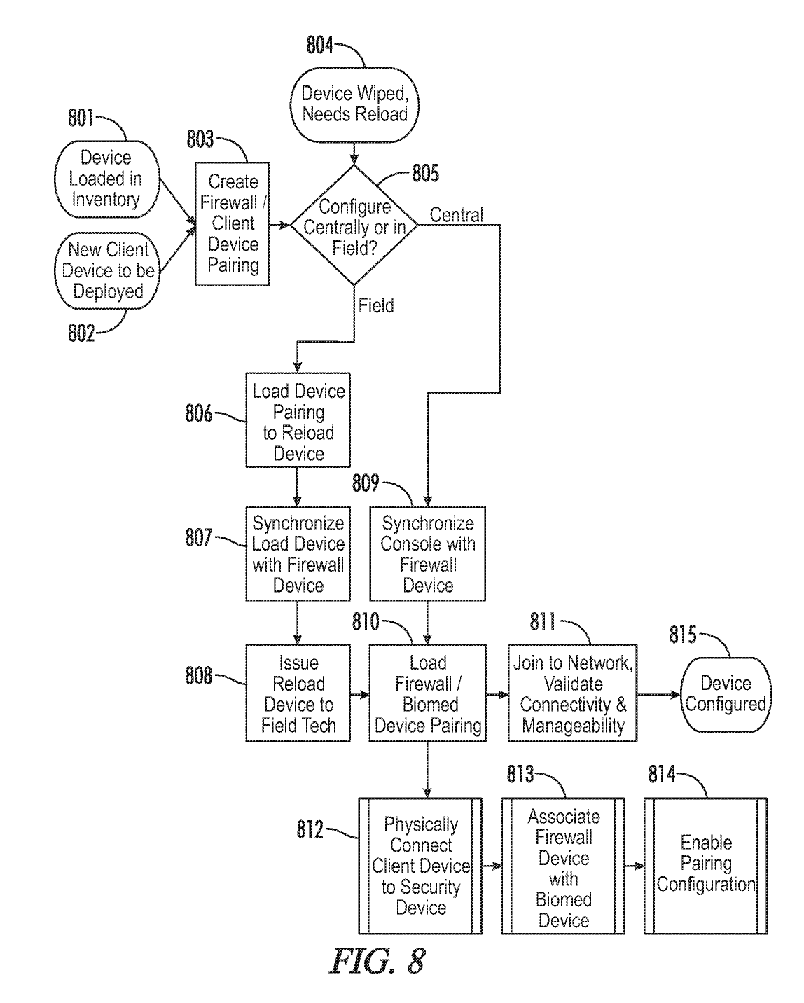

FIG. 8 is a flow chart showing one embodiment of a method to set up a client unit 200 using the system of FIG. 7. The method of FIG. 8 can be used starting from step 801 where firewall, client and reload device profiles have already been created according to the methods of FIGS. 5A, 5B and 5C, for example. The method of FIG. 8 can also be used starting from step 802 where a new client device, for example, is to be added into the system inventory for immediate deployment on the network. Alternatively, the method of FIG. 8 can be used starting from step 804 where the firewall device 202 of an existing client unit deployed on the network has been wiped and must be reloaded and set up for operation on the network. If starting at steps 801 or 802, device profiles are first created as necessary and as described in FIGS. 5A, 5B, and 5C and firewall devices 202 are paired with client devices 203 in the databases and inventories of client unit management servers 207, as shown in step 803. At step 805, network managers or technicians decide whether to configure the firewall device 202 to be used in the client unit 200 centrally using a management console or remotely in the field. If the firewall device 202 is to be configured in the field, in step 806 the reload device 600 can be loaded with network access data and configuration files 610 for the firewall and client device pairing to be used in the specific client unit 200 being deployed on the network. This information can include configurations generated from the profile data created using the methods of FIG. 5. Because the exact pairings are known at this stage, servers 207 can generate and load onto reload device 600 configuration files 610 including specific routing tables, firewall rules, IDS configuration files and management configuration files specific to this client unit 200 deployment. It will be understood multiple configuration files 610a, 610b and 610c can be loaded onto reload device for multiple client unit pairings. In step 807, via management consoles, servers 205 and 207 can be synchronized with the firewall device 202 to associate the firewall device 202 and the reload device 600 that will be used for the reload operation. Client unit management servers 207 can also load the temporary reload cryptographic keys and configurations into the network management and security servers 205 that will be used for this reload operation. The reload device 600 is then issued to the field technician in step 808 to reload and set up the specific client unit 200 in the location of intended use.

Alternatively, if the firewall device 202 is to be centrally configured, in step 809 servers 205 and 207 can be synchronized with the firewall device 202 to associate the firewall device 202 and the reload device 600 that will be used for the reload operation using identification information regarding the reload device 600 entered via management consoles. As with the method used for field configuration, client unit management servers 207 can also load the temporary reload cryptographic keys and configurations into the network management and security servers 205 that will be used for this reload operation.

In the field at step 810, the field technician can input identifiers, such as serial numbers or bar code information representing serial numbers, for the firewall device 202 and the client device 203 pairing of the client unit 200 that is about to be reloaded into reload device 600. In step 812, the technician can ensure the paired client device 203 and firewall device 202 are physically connected via data cable 230 connected between data ports 211 and 212. In step 813, the reload device 600 can be wirelessly connected to the firewall device 202 of the client unit being reloaded. The wireless communication can be established using the reload radio on the reload device 600 securely connected to the reload radio of firewall device 202. Reload device 600 can control processor 221 in the firewall device 202 to boot up using code stored in volatile memory 607 and can also temporarily disable the wipe module 232 of the firewall device 202. Reload device can then control firewall device 202 to retrieve a client unit identifier from the firewall device that uniquely identifies the firewall device and connected client device 203 pair. Reload device 600 can also establish a secure wireless connection with wireless access point 210 and upon confirming the correct client unit pairing, transmit confirming data to management and security servers 205. In establishing a secure communication with servers 205, the reload device can use temporary reload cryptographic keys to transmit authenticating data that can include the client unit identifier that will be used by authenticator 701. Authenticator 701 can be a server connected to wireless access point 210 that controls access to VLAN 204 and 201 using authentication information retrieved from management and security servers 205. In step 814, reload device can load a selected the appropriate configuration files 610c from the set of configuration files 610 stored in its memory as well as authentication data such as digital certificates, based on the client unit identifier received from the client unit 200. The appropriate configuration files 610c and digital certificates can be stored exclusively in volatile memory 301 of firewall device 202 Alternatively, if the firewall device 203 is to be centrally configured, the reload device 600 can control the firewall device 202 to communicate directly with management and security servers 205 using temporary reload cryptographic keys provided by the reload device 600 to authenticate the firewall device's communication using its reload radio 213 securely connected to wireless access point 210. Using this secure wireless connection to wireless access point 210, firewall device 202 can retrieve appropriate configuration files and authentication data (such as digital certificates) from servers 205 and 207 and store the files and data in volatile memory 301.

Once the configuration files 610c and digital certificates have been loaded into the firewall device 202, reload device 600 can control firewall device to establish a secure connection between wireless radio 218 of firewall device 202 and wireless access point 210 in step 811. With the client unit 200 now set up and securely connected to the network and authenticated using management and security servers 205, the reload device 600 confirms the proper operation of the client unit 200 and confirms the client unite is properly configured in step 815. The reload device can then disconnect from firewall device 202 and wireless access point 210.

Thus it is seen that the apparatus and methods disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A distributed firewall device comprising:
a processor coupled to a memory having a volatile memory and to a network module, the network module configured to interface with a wireless network and with a client device;
a firewall program stored in memory, the firewall program configured to monitor network data the network module receives from the wireless network and to permit transmission of allowed network data to a client device, the firewall program also configured to monitor client device data the network module receives from the client device and permit transmission of allowed client device data to the wireless network, the firewall program using a configuration stored only in volatile memory to identify allowed network data and allowed client device data;
a wipe module stored in memory and configured to monitor the security state of the firewall device and to clear the configuration from volatile memory upon detection of a security threat.

2. The distributed firewall device of claim 1, wherein the configuration includes a firewall ruleset.

3. The distributed firewall device of claim 1, wherein the communication configuration includes a routing table.

4. The distributed firewall device of claim 1, wherein the communication configuration includes a digital authentication certificate.

5. The distributed firewall device of claim 1, wherein the wipe module is configured to clear the configuration by clearing the volatile memory.

6. The distributed firewall device of claim 1, wherein the security threat includes disconnection of the firewall device from the client device, disconnection of the firewall device from the wireless network, detection of one or more prohibited network data packets, or loss of power to the client device.

7. The distributed firewall device of claim 1, wherein the client device is a medical device.

8. A method in a reload device for connecting a firewall device to a wireless network comprising:
connecting the reload device to a client unit, the client unit including the firewall device having a wipe module and client device, wherein the firewall device is hardwired to the client device;
receiving in the reload device a client unit identifier from the client unit, the client unit identifier uniquely identifying the firewall device and hardwired client device pairing;
identifying, using the reload device and based on the received client unit identifier, a desired configuration;
disabling the wipe module;
loading the desired configuration into a volatile memory of the firewall device;
controlling the firewall device to connect to the wireless network using the loaded configuration;
enabling the disabled wipe module.

9. The method of claim 8, wherein the client device is a medical device.

10. The method of claim 8, wherein the configuration includes a digital authentication certificate.

11. The method of claim 8, wherein the communication configuration includes a firewall ruleset.

12. The method of claim 8, wherein the configuration includes a routing table.

13. A method of protecting a client device, the method comprising:
providing a client unit that includes a firewall device and a client device, the firewall device having volatile memory, non-volatile memory, and a wipe module in stored in non-volatile memory, the firewall being hardwired to the client device,
wherein the firewall device is connected to a wireless network using a configuration stored only in volatile memory,
wherein the firewall device is configured to monitor network data the network module receives from the wireless network, only permitting transmission of allowed network data to a client device, and also configured to monitor client device data received from the client device, only permitting transmission of allowed client device data to the wireless network, and
wherein the firewall device is configured to monitor the client unit for security threats and to control the wipe module to erase the volatile memory on detecting a first security threat;
controlling the firewall device to erase the volatile memory on detecting the first security threat and to disconnect from the secure wireless network.

14. The method of claim 13, wherein the client device is a medical device.

15. The method of claim 13, wherein the configuration includes a digital authentication certificate.

16. The method of claim 13, wherein the configuration includes a firewall ruleset.

17. The method of claim 13, wherein the configuration includes a routing table.

18. The distributed firewall device of claim 13, wherein the security threat includes disconnection from the client device, disconnection from the wireless network, detection of one or more prohibited network data packets, or loss of power to the client device.
